(19) United States
(12) Patent Application Publication
(10) Pub. No.: US 2005/0050182 A1
(43) Pub. Date: Mar. 3, 2005

(54) Peripheral device diagnostic method and architecture

(75) Inventors: Russell S. Neville, Tualatin, OR (US); David I. Bernklau Halvor, Portland, OR (US)

Correspondence Address: Gregory P. Gadson, Esq.;Gonzalez, Saggio & Harlan, L.L.P., Suite 1900, 201 North Illinois Street, Indianapolis, IN, 46204, US

(73) Assignee: Xerox Corporation

(21) Appl. No.: 10/648,414

(22) Filed: Aug. 26, 2003

(51) Int. Cl. G06F 15/173

(52) U.S. Cl. 709/223

(57) ABSTRACT

A method for performing diagnostics on a computer peripheral device at least includes: coupling a computer at least including a web browser to a backend server via a communication link; via a peripheral device coupled to the computer and at least including a web server, constructing and sending a peripheral device HTTP message to the web browser at least including peripheral device functionality information; via the web browser, forwarding the peripheral device HTTP message to the backend server; via the backend server, and in response to receiving the peripheral device HTTP message, constructing and transmitting a directive web page to the peripheral device requesting more information if more information is needed, or a constructing and transmitting a human readable web page to the web browser, indicating diagnostic results if more information is not needed; via the web server, automatically responding to a directive web page with a new peripheral device HTTP message at least including functionality information; and iteratively communicating between the backend server and the peripheral device is until a user communication point is reached, which communication point precedes transmitting the human readable web page.

### 1. FIELD OF THE INVENTION

The present invention generally relates to computer peripheral device diagnostics. More specifically, the present invention relates to improved diagnostics and troubleshooting for computer peripheral devices such as printers, in an environment where at least part of the diagnostic tool may be remotely located.

### 2. BACKGROUND OF RELATED ART

While the reliability of computer peripheral devices such as printers has improved over the years, the periodic encounter of problems, malfunction, and performance eccentricities are very difficult to entirely eliminate. As a result, many peripheral devices provide information to a user when problems occur that will allow the user to place the peripheral device in proper working order.

It is also common for many peripheral devices to execute a diagnostic program upon power-up to determine whether the device will be able to function normally when it is required to carry out a task. It is also not unusual for peripheral devices to run diagnostic programs when a malfunction or other disability occurs. In the case of reproduction peripheral devices such as printers, a number of problems can be encountered that may lead to the inability to properly execute a print job, including, inter alia, insufficient consumables such as ink and paper, mechanical failure or mechanical aberration that may be difficult for a user to detect or diagnose, electric and electronic failure or aberration, and software bugs.

As peripheral devices have become more complex, there is often a concomitant need for more complex diagnostics that the device may not be capable of running on its own.

More advanced to the closed troubleshooting system described above is a system which allows a peripheral device to collect and send data to a remote location in the form of an error report. The remote location can be as simple as a network server (such as one connected to the peripheral device by a Local Area Network or LAN) or a server accessible over the Internet. In either case, the remote server analyzes the data sent and provides a single response back to the user with a resolution, if the user is fortunate, or an error report. Even using these advanced prior art approaches, the user is often faced with engaging in a great deal of human interaction with the peripheral device and the remote server to diagnose the problem and not knowing what to do or which actions to try, or having to contact a technical support representative.

What is greatly needed is a troubleshooting scheme which relies on the capabilities of an expert troubleshooting system that is readily accessible to a large number of peripheral device users. And what is also needed is a scheme which unlike heretofore methods, provides an interactive and iterative dialog between the peripheral device and the expert system for automated problem resolution with little or no human intervention until a suitable point has been reached.

### SUMMARY

In view of the above-identified problems and limitations of the prior art, the present invention provides a method for performing diagnostics on a computer peripheral device, the method at least including: coupling a computer at least including a web browser to a backend server via a communication link; via a peripheral device coupled to the computer and at least including a web server, constructing and sending a peripheral device HTTP message to the web browser at least including peripheral device functionality information; via the web browser, forwarding the peripheral device HTTP message to the backend server; via the backend server, and in response to receiving the peripheral device HTTP message, constructing and transmitting a directive web page to the peripheral device requesting more information if more information is needed, or a constructing and transmitting a human readable web page to the web browser, indicating diagnostic results if more information is not needed; via the web server, automatically responding to a directive web page with a new peripheral device HTTP message at least including functionality information; and iteratively communicating between the backend server and the peripheral device is until a user communication point is reached, which communication point precedes transmitting the human readable web page.

The present invention also provides a system for performing diagnostics on a computer peripheral device, the system at least including: a backend server; a computer comprising a web browser; a communication link coupled between said computer and said backend server; and a peripheral device coupled to said computer and comprising a web server, said web server adapted to construct and send a peripheral device HTTP message to said web browser comprising peripheral device functionality information; wherein said web browser is adapted to forward said peripheral device HTTP message to said backend server, and said backend server is adapted to, in response to receiving said peripheral device HTTP message, construct and transmit a directive web page to said peripheral device requesting more information if more information is needed, direct the peripheral device to execute self-diagnostics to obtain additional information, or a human readable web page to said web browser, indicating diagnostic results if more information is not needed, and said web server is adapted to automatically respond to a directive web page with a new peripheral device HTTP message comprising functionality information, and the communication between said backend server and said peripheral device is iterative until a user communication point is reached, which communication point precedes transmitting said human readable web page.

The teachings of the present invention can be applied to any number of devices, appliances and apparatuses that can be connected to the Internet via a local computer. What is required of any such device, appliance or apparatus is that it have either embedded or connected thereto, a web server as described infra, and supporting logic for gathering status and functionality information, as well as for executing commands received from the backend server.

### BRIEF DESCRIPTION OF THE DRAWINGS

Features of the present invention will become apparent to those skilled in the art from the following description with reference to the drawings, in which:

FIG. 1 is a general schematic diagram of the present-inventive system capable of automated, interactive diagnostics between a computer peripheral device such as a printer and a remote backend server; and

FIG. 2 is a flowchart detailing the steps employed by the present-inventive method for an automated, interactive diagnostics operation between a computer peripheral device such as a printer and a remote backend server.

### DETAILED DESCRIPTION

The terms “peripheral,” “computer peripheral,” and “peripheral device” refer, for example, to any apparatus that can interface with a computer, whether it be a conventional computer peripheral device such as a printer, or other devices such as appliances with computer interfaces.

To summarize, the present invention is a method and architecture that provides for the automated, interactive and iterative communication between a peripheral device and a backend server over the World Wide Web for the resolution of problems with the peripheral device. Once initiated by the user, the interactive communication between the peripheral device and the backend server continues until the problem is solved, or if it cannot be solved, human interaction is allowed in the form of response to human readable web pages from the backend server. In contrast to prior art methods of remote diagnostics and troubleshooting, which provides for collecting and sending data, and then only a single response, the present invention provides for automated interactivity between the peripheral device and the backend server for greater ability to resolve peripheral device problems. The peripheral devices have embedded web servers and additional logic capable of collecting device functionality information and constructing a web page including the functionality information.

The method leverages the user's web browser to open a communication channel with the backend server via the Internet. The communication uses the Hyper Text Transport Protocol (HTTP), with the web pages generated by the device web server and the backend server utilizing the Hyper Text Markup Language (HTML). In the case of a printer, the device functionality data is gathered by a PostScript (although it is possible to utilize another page description language) function interface, and it is included in the web page using the Extensible Markup Language (XML). The web pages sent from the backend server utilize JavaScript to open status windows which can be read by the user when this is appropriate, and when more information is needed from the peripheral device, utilize META redirect tags to instruct the peripheral device to send more information (with or without the execution of commands, such as performing diagnostic operations).

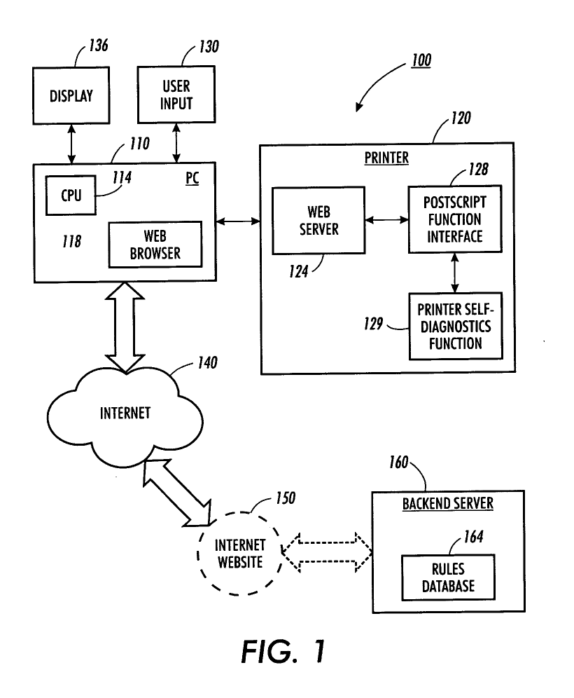

The present-inventive troubleshooting and diagnostic system and architecture 100 are generally illustrated in FIG. 1.

A conventional computer such as a personal computer (PC) 110 is connected to one or more peripheral devices such as a printer 120. As will be understood by those skilled in the art, the computer includes a user input 130 (a keyboard, mouse, or both), and a display 136, and may contain an audio reproduction device (not shown). As well as a CPU 114 and other components not shown, the computer 110 also includes a web browser 118 for locating and displaying web pages as is customary.

The computer 110 via its web browser 118 can connect to an expert system for troubleshooting and diagnosing peripheral device problems in the form of a backend server 160. The connection is by way of the Internet 140 and an optional Internet website 150 responsible for maintaining the backend server 160. The backend server 160 contains a comprehensive rules-based database for responding to information received from the peripheral device undergoing a troubleshooting operation, in the form of evaluating the information, requesting additional information, ordering the device to execute commands, such as additional diagnostics, and having the ability to cause the construction of human readable web pages when the operation has reached a user communication point.

The printer 120 contains a web server 124 for constructing a web page. The web server also calls a PostScript function interface 128, which collects data about the Post-Script functions of the printer.

To start a troubleshooting/diagnostic operation the user initiates (via the computer 110) an HTTP request for a web page to the web server 124 of the printer 120. In response, the web server makes a PostScript function call to the PostScript function interface 128. The PostScript function interface gathers data on the PostScript functions of the printer and transmits the data to the web server in the XML format. The data is also compressed and encrypted. The web server 124 then constructs an HTTP message that is submitted to the web browser 118 with at least one hidden input element containing the XML data. The HTTP message also contains in its body tag, a directive for the web browser to automatically submit the HTTP message via HTTP POST to the backend server 160.

The backend server 160 decrypts and decompresses the information from the HTTP message and utilizes the rules database 164 to determine the backend server's course of action. If the rules database 164 determines that no more information is required, the response web page transmitted to the web browser 118 contains JavaScript that enables the web browser to open a human readable status window with the status and/or results of the troubleshooting operation. If the rules database determines that more information is needed or more diagnostics need to be run by the printer, the web page from the backend server contains a META redirect tag either requiring the web server to construct the same previously submitted page with different parameters, or a separate web page. The web page from the backend server can also contain portions of code to be executed to manipulate aspects or features of the printer, and/or instructions to carry out further diagnostics. In response, the web server follows the instructions and initiates a new PostScript function call to the PostScript function interface 128. Responding to specific PostScript function calls, the PostScript function interface 128 causes the peripheral device to run self-diagnostics tests via a printer diagnostic function 129.

The web server 124 and backend server 160 continue to interact without user intervention by sending web pages to each other until a user communication point is reached. The user readable web page is then sent as described supra.

The results of the troubleshooting session conveyed to the user include: a solution to the peripheral device problem, an error message, a report of the state of consumables used by the peripheral device, a report of the communication between the peripheral device and the backend server, confirmation of the information submitted from the peripheral device, a form for user interaction or information, the results of printer self-diagnostics indicating either that the diagnostics passed or that a specific peripheral device component replaceable by a user has failed, and others.

It is also possible to open a status window while the redirect web page is forwarded to the web server.

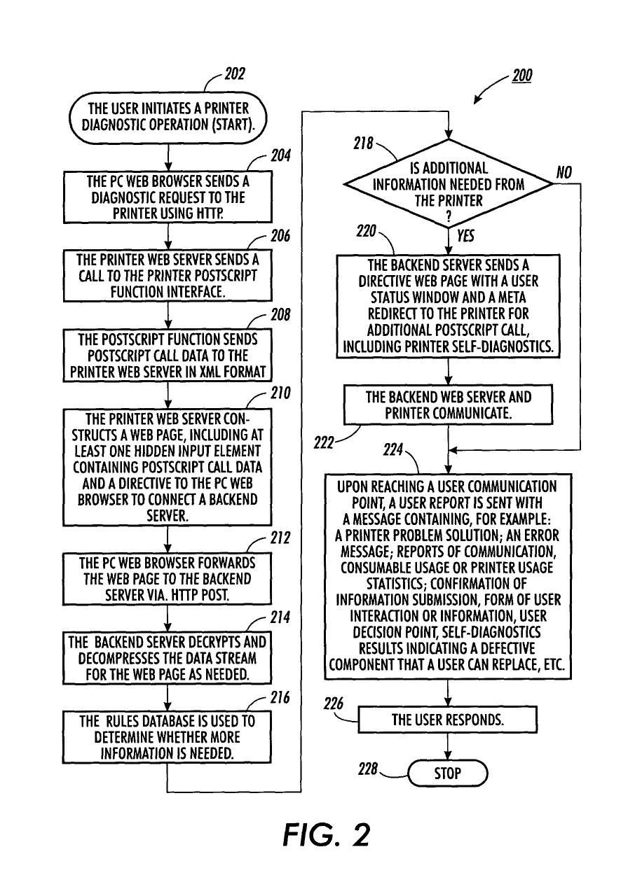

The automated diagnostic/troubleshooting program 200 of the present invention is illustrated in the flowchart of FIG. 2. The process is started by the user initiating a printer diagnostic operation (Step 202). The PC web browser sends a diagnostic request to the printer using HTTP (Step 204).

In Step 206, the printer web server sends a call to the PostScript function interface, which determines the PostScript function status of the printer and returns the status information data to the web server in XML format (Step 208). The web server constructs an HTTP message including at least one hidden input element containing PostScript call data and a directive to the PC web browser to connect to the backend server (Step 210). The PC web browser forwards the HTTP message to the backend server via HTTP POST (Step 212).

In Step 214, the backend server decrypts and decompresses the data stream from the received HTTP message. The backend server determines whether more information is needed from the printer in Steps 216 and 218. If no more information is needed, the program jumps from Step 218 to Step 224 (the user communication point). Upon reaching the user communication point, a user report is sent with a message containing, for example: a printer problem solution; an error message; reports of communication, consumable usage or printer usage statistics; confirmation of information submission, form of user interaction or information, user decision point, etc. (Step 224).

If on the other hand, more information is needed, the program advances from Step 218 to Step 220, whereupon the backend server sends a directive web page to establish a user status window and a META redirect to the printer for an additional PostScript call, including PostScript snippets if appropriate, or directing the peripheral device to run self-diagnostic tests on itself. The printer and the backend server continue to communicate in an interactive fashion until a user communication point is reached (Step 222).

Following Step 224, the user responds as needed in Step 226. The program stops in Step 228.

Variations and modifications of the present invention are possible, given the above description. However, all variations and modifications which are obvious to those skilled in the art to which the present invention pertains are considered to be within the scope of the protection granted by this Letters Patent.

1. A method for performing diagnostics on a computer peripheral device, said method comprising:
coupling a computer comprising a web browser to a backend server via a communication link;
via a peripheral device coupled to said computer and comprising a web server, constructing and sending a peripheral device HTTP message to said web browser comprising peripheral device functionality information;
via said web browser, forwarding said peripheral device HTTP message to said backend server;
via said backend server, and in response to receiving said peripheral device HTTP message, constructing and transmitting a directive web page to said peripheral device requesting more information if more information is needed, or a constructing and transmitting a human readable web page to said web browser, indicating diagnostic results if more information is not needed;
via said web server, automatically responding to a directive web page with a new peripheral device HTTP message comprising functionality information; and
iteratively communicating between said backend server and said peripheral device is until a user communication point is reached, which communication point precedes transmitting said human readable web page.

2. The method of claim 1, wherein said peripheral device is an image reproduction device.

3. The method of claim 2, wherein said image reproduction device is a printer.

4. The method of claim 1, further comprising, via a PostScript function interface, generating said peripheral device functionality information in response to a call from said web server.

5. The method of claim 1, wherein said communication link comprises the World Wide Web.

6. A method for performing diagnostics on a computer peripheral device, said method comprising:
coupling a computer comprising a web browser to a backend server via a communication link;
via a peripheral device coupled to said computer and comprising a web server, constructing and sending a peripheral device HTTP message to said web browser comprising peripheral device functionality information;
via said web browser, forwarding said peripheral device HTTP message to said backend server;
via said backend server, and in response to receiving said peripheral device HTTP message, constructing and transmitting a directive web page to said peripheral device requesting more information if more information is needed, or a constructing and transmitting a human readable web page to said web browser, indicating diagnostic results if more information is not needed;
via said web server, automatically responding to a directive web page with a new peripheral device HTTP message comprising functionality information;
iteratively communicating between said backend server and said peripheral device is until a user communication point is reached, which communication point precedes transmitting said human readable web page; and
via a rules-based diagnostic database subsumed by said backend server, constructing and transmitting iterative responses to peripheral HTTP messages.

7. The method of claim 1, further comprising, in response to code in said redirect web pages, said peripheral device executing said code to manipulate features of said peripheral device.

8. The method of claim 1, wherein said diagnostic results comprise a user executable solution to a problem experienced by said peripheral device.

9. The method of claim 1, wherein said diagnostic results comprise a solution to a problem experienced by said peripheral device which can be remedied by replacing a user-replaceable peripheral device component.

10. The method of claim 1, wherein said web pages utilize Hyper Text Markup Language (HTML).

11. The method of claim 1, wherein said peripheral device functionality information comprises data in Extensible Markup Language (XML) format.

12. A system for performing diagnostics on a computer peripheral device, said system comprising:
a backend server;
a computer comprising a web browser;
a communication link coupled between said computer and said backend server; and
a peripheral device coupled to said computer and comprising a web server, said web server adapted to construct and send a peripheral device HTTP message to said web browser comprising peripheral device functionality information;
wherein said web browser is adapted to forward said peripheral device HTTP message to said backend server, and said backend server is adapted to, in response to receiving said peripheral device HTTP message, construct and transmit a directive web page to said peripheral device requesting more information if more information is needed, or a human readable web page to said web browser, indicating diagnostic results if more information is not needed, and said web server is adapted to automatically respond to a directive web page with a new peripheral device HTTP message comprising functionality information, and the communication between said backend server and said peripheral device is iterative until a user communication point is reached, which communication point precedes transmitting said human readable web page.

13. The system of claim 12, wherein said peripheral device is an image reproduction device.

14. The system of claim 13, wherein said image reproduction device is a printer.

15. The system of claim 12, wherein said peripheral device further comprises a PostScript function interface adapted to generate said peripheral device functionality information in response to a call from said web server.

16. The system of claim 12, wherein said communication link comprises the World Wide Web.

17. The system of claim 12, wherein said backend server comprises a rules-based diagnostic database adapted to indicate iterative responses to peripheral device HTTP messages.

18. The system of claim 12, wherein said redirect web pages comprise code executable by said peripheral device to manipulate features of said peripheral device.

19. The system of claim 12, wherein said diagnostic results comprise a user executable solution to a problem experienced by said peripheral device.

20. The system of claim 12, wherein said diagnostic results comprise a solution to a problem experienced by said peripheral device which can be remedied by replacing a user-replaceable peripheral device component.

21. The system of claim 12, wherein said web pages utilize Hyper Text Markup Language (HTML).

22. The system of claim 12, wherein said peripheral device functionality information comprises data in Extensible Markup Language (XML) format.
